(19) United States
(12) Patent Application Publication
(10) Pub. No.: US 2009/0006966 A1
(43) Pub. Date: Jan. 1, 2009

(54) Creating A Usability Observation Video For A Computing Device Being Studied For Usability

(76) Inventors: William K. Bodin, Austin, TX (US); Ann M. Maynard, Austin, TX (US); Derral C. Thorson, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/769,391

(22) Filed: Jun. 27, 2007

(51) Int. Cl. G06F 3/00

(52) U.S. Cl. 715/723

(57) ABSTRACT

Methods, systems, and products are disclosed for creating a usability observation video for a computing device being studied for usability that include: recording, by a digital video recorder as a usability observation video, a user interacting with a computing device during a usability session for studying the usability of the device; detecting, by an event listener on the computing device, an event generated as a result of user interaction with the device; notifying, by the event listener, a usability engine of the event; and supplementing, by the usability engine, the usability observation video with a description of the event.

### BACKGROUND OF THE INVENTION

1. Field of the Invention

The field of the invention is data processing, or, more specifically, methods, systems, and products for creating a usability observation video for a computing device being studied for usability.

2. Description Of Related Art

When computer architects design a computing device and its software, these architects often make a great effort to ensure that the device is convenient and easy to use from the perspective of a user. For example, the buttons on the device should be easily accessible when needed for device interaction, while not hindering the user's interaction with the device when the buttons are not in use. As a further example, the graphical user interface of a device should be logically arranged and configured from the user's perspective such that the user's interaction with the device is intuitive for the user.

To ensure that a computing device is convenient and easy to use from a user's perspective, computer architects typically perform usability studies on the interaction of a user with the computing device. Usability refers to a full range of aspects that impact a user's success and satisfaction when interacting with the device. Usability encompass issues such as, for example, a user's understanding of how to operate the device's interface, the ease with which a user is able to physically manipulate the device and its controls, a user's emotions while interacting with the device, the correspondence between the user's desired output from the device and the output actually produced by the device, and so on. In studying a device's usability, high usability is generally regarded as a desirable feature of the device.

Usability studies have traditionally been conducted by having a video recorder record a user interacting with a computing device. The drawback to this traditional approach to studying usability is that the information recorded on the video is limited to the observations capable of being observed by a video recorder. As devices have become smaller and more complex, the ability of a video recorder to record importance aspects affecting the user's interaction with a computing device have been greatly diminished. In particular, some aspects of the user's interaction may not be observable by the video recorder at all. As such, readers will appreciate that room for improvement exists in the area of studying the usability of a computing device.

### SUMMARY OF THE INVENTION

Methods, systems, and products are disclosed for creating a usability observation video for a computing device being studied for usability that include: recording, by a digital video recorder as a usability observation video, a user interacting with a computing device during a usability session for studying the usability of the device; detecting, by an event listener on the computing device, an event generated as a result of user interaction with the device; notifying, by the event listener, a usability engine of the event; and supplementing, by the usability engine, the usability observation video with a description of the event.

The foregoing and other features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for creating a usability observation video for a computing device being studied for usability according to embodiments of the present invention.

FIG. 2 sets forth a block diagram of automated computing machinery comprising an exemplary computing device useful in creating a usability observation video for a computing device being studied for usability according to embodiments of the present invention.

FIG. 3 sets forth a flow chart illustrating an exemplary method of creating a usability observation video for a computing device being studied for usability according to embodiments of the present invention.

FIG. 4 sets forth a flow chart illustrating a further exemplary method of creating a usability observation video for a computing device being studied for usability according to embodiments of the present invention.

FIG. 5 sets forth a flow chart illustrating a further exemplary method of creating a usability observation video for a computing device being studied for usability according to embodiments of the present invention.

FIG. 6 sets forth a flow chart illustrating a further exemplary method of creating a usability observation video for a computing device being studied for usability according to embodiments of the present invention.

### DETAILED DESCRIPTION OF EXEMPLARY EMBODIMENTS

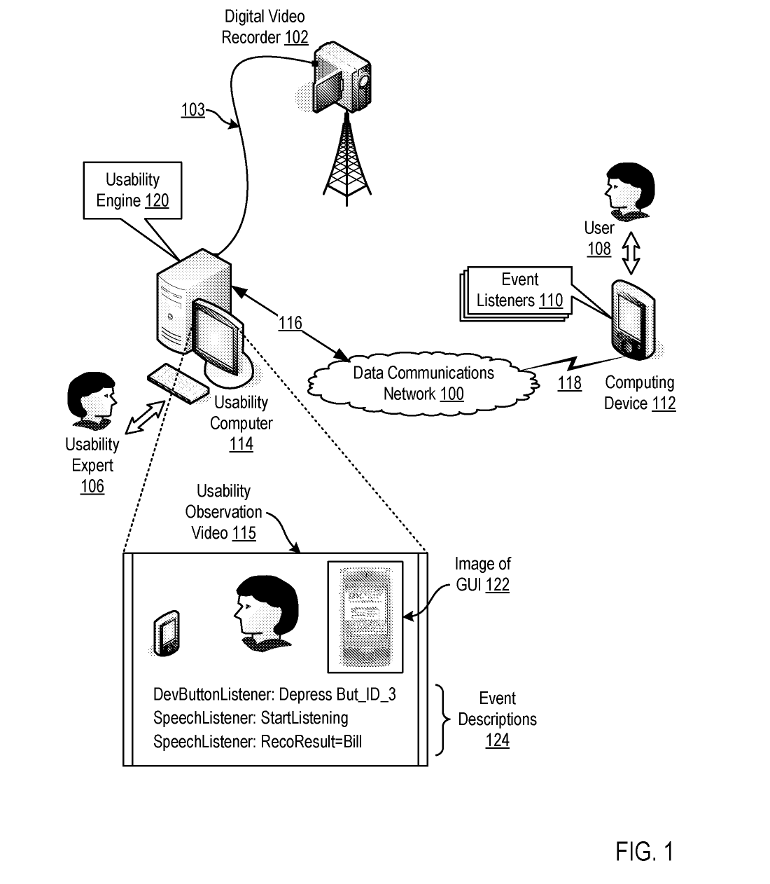

Exemplary methods, systems, and products for creating a usability observation video for a computing device being studied for usability in accordance with the present invention are described with reference to the accompanying drawings, beginning with FIG. 1. FIG. 1 sets forth a network diagram of a system for creating a usability observation video for a computing device being studied for usability according to embodiments of the present invention. The exemplary system of FIG. 1 operates generally for creating a usability observation video for a computing device being studied for usability according to embodiments of the present invention as follows: A digital video recorder (102) records, as a usability observation video (115), a user (108) interacting with a computing device (112) during a usability session for studying the usability of the device (112). An event listener (110) on the computing device (112) detects an event generated as a result of user interaction with the device (112) and notifies a usability engine (120) of the event. The usability engine (120) then supplements the usability observation video (115) with a description (124) of the event.

The exemplary system of FIG. 1 includes a computing device (112) connected to a data communications network (100) through wireless connection (118). The computing device (112) of FIG. 1 is being studied for usability by a usability expert (106) during a usability session. A usability session is a period of time dedicated by a usability expert to study the usability of a particular computing device. The usability expert (106) is a person who specializes in the study of how people interact with and use computing devices. A usability expert may possess general knowledge regarding the field of usability or may specialize in certain aspects of usability. For example, a usability expert may specialize as a cognitive psychologist, user interface specialist, an application expert, a language specialist, and so on.

In the exemplary system of FIG. 1, readers will note that the computing device (112) is implemented as a personal digital assistant (‘PDA’). Readers will note, however, that such an implementation is for example only and not for limitation. In fact, the computing device (112) may be implemented as any general-purpose or special-purpose computing device as will occur to those of skill in the art. Examples of computing devices may include desktop computers, laptop computers, cell phones, gaming consoles, PDAs, personal video recorders, and any other computing device as will occur to those of skill in the art.

In the example of FIG. 1, the usability expert (106) uses a digital video recorder (102) to record as a usability observation video (115) the user (108) interacting with the computing device (112) during a usability session for studying the usability of the device (112). The digital video recorder (102) is a portable electronic device for capturing video images and audio and recording video images and audio onto a storage medium. The storage medium may include, for example, flash memory, video tape, or any other storage medium as will occur to those of skill in the art. The digital video recorder (102) typically captures, transmits, and stores the usability observation video (115) using an encoder/decoder (‘codec’) such as, for example, Cinepak, Motion JPEG, MPEG, and so on. In the example of FIG. 1, the digital video recorder (102) transmits the usability observation video (115) for storage on the usability computer (114) through the data communications cable (103). The data communications cable (103) may be implemented as a Universal Serial Bus cable, Serial Digital Interface cable, FireWire cable, High-Definition Multimedia Interface Cable, or any other data communications cable as will occur to those of skill in the art.

The usability observation video (115) recorded by the digital video recorder (102) is a digital video. A digital video is a collection of digital frames typically used to create the illusion of a moving picture. Each frame of digital video includes image data for rendering one still image and metadata associated with the image data. The metadata of each frame may include synchronization data for synchronizing the frame with an audio stream, configurational data for devices displaying the frame, closed captioning data, and so on. Each frame is typically displayed by a display device that flashes each frame on a display screen for a brief period of time, typically 1/24th, 1/25th or 1/30th of a second, and then immediately replaces the frame displayed on the display screen with the next frame of the digital video. As a person views the display screen, persistence of vision in the human eye blends the displayed frames together to produce the illusion of a moving image.

In the exemplary system of FIG. 1, the computing device (112) has installed upon it several event listeners (110). An event listener is a software component that detects the occurrence of an event that was generated as a result of user interaction with the device (112). The event listeners (110) of FIG. 1 may be able to detect the occurrence of events such as, for example, when a user depresses or releases a button on the device (112), when the user selects components on the device's graphical user interface, when software on the device processes a user's request or provides the user with output, and so on. An event listener may be implemented as interrupt handler, instrumentation code having instrumentation hooks embedded in other software components, a subroutine called by another software module, or any other implementation as will occur to those of skill in the art. In the example of FIG. 1, each event listener (110) operates for creating a usability observation video for a computing device being studied for usability according to embodiments of the present invention. Each event listener (110) of FIG. 1 operates for creating a usability observation video for a computing device being studied for usability according to embodiments of the present invention by detecting an event generated as a result of user interaction with the device and notifying the usability engine (120) of the event. In the example of FIG. 1, each event listener (110) may notify the usability engine (120) of the event using data communications architectures such as, for example, web services, CORBA, Java™ Remote Method Invocation API, and so on.

‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java™ Remote Method Invocation API is a Java application programming interface for performing remote procedural calls published by Sun Microsystems™. The Java™ RMI API is an object-oriented way of making remote procedure calls between Java objects existing in separate Java™ Virtual Machines that typically run on separate computers. The Java™ RMI API uses a remote procedure object interface to describe remote objects that reside on the server. Remote procedure object interfaces are published in an RMI registry where Java clients can obtain a reference to the remote interface of a remote Java object. Using compiled ‘stubs’ for the client side and ‘skeletons’ on the server side to provide the network connection operations, the Java™ RMI allows a Java client to access a remote Java object just like any other local Java object.

The exemplary system of FIG. 1 also includes a usability computer (114) connected to the data communications network (100) through wireline connection (116). The usability computer (114) of FIG. 1 has installed upon it a usability engine (120). The usability engine (120) is a software component that receives event notifications from one or more event listeners (110) detecting events on the device (112) during the usability session and that administers the usability observation video (115) recorded by the digital video recorder (102). The usability engine (120) of FIG. 1 includes computer program instructions configured for creating a usability observation video for a computing device being studied for usability according embodiments of the present invention. The usability engine (120) of FIG. 1 operates generally for creating a usability observation video for a computing device being studied for usability according embodiments of the present invention by supplementing the usability observation video (115) with a description (124) of an event detected by one of the event listeners (110).

In the exemplary system of FIG. 1, the usability engine (120) may supplement the usability observation video (115) with a description (124) of an event detected by one of the event listeners (110) by recording the description (124) of the event in a session log, identifying the portion of the usability observation video (115) recorded when the event was detected using timecodes embedded in the usability observation video (115), and associating the description (124) of the event with the identified portion of the usability observation video (115). The usability engine (120) of FIG. 1 may also supplement the usability observation video (115) with a description (124) of an event detected by one of the event listeners (110) by identifying the portion of the usability observation video (115) recorded when the event was detected using timecodes embedded in the usability observation video (115), and embedding the description (124) of the event in the identified portion of the usability observation video (115).

Supplementing the usability observation video (115) with a description (124) of an event detected by one of the event listeners (110) assists the usability expert (106) viewing the video (115) in developing a more accurate assessment of the device's usability. In addition to supplementing the usability observation video (115) with a description (124) of an event detected by one of the event listeners (110), the usability engine may also provide the usability expert (106) with an image of the device's graphical user interface to further assist the usability expert (106) in assessing the usability of the device (112). As such, the usability engine (120) of FIG. 1 may also operate generally for creating a usability observation video for a computing device being studied for usability according embodiments of the present invention by: providing, by the event listener (110) to the usability engine (120) in response to detecting an event, an image (122) of a graphical user interface of the device (112); identifying the portion of the usability observation video (115) recorded when the event was detected using timecodes embedded in the usability observation video (115); and displaying concurrently the identified portion of the usability observation video (115) and the image (122) of the graphical user interface of the device (112).

As the usability expert (106) views the usability observation video, the usability expert (106) may provide observation data that can be used to supplement the usability observation video (115). To implement such a feature, the usability engine (120) of FIG. 1 may also operate generally for creating a usability observation video for a computing device being studied for usability according embodiments of the present invention by: displaying the usability observation video (115) to a usability expert (106); receiving usability observations from the usability expert (106); and supplementing the usability observation video (115) with the usability observations.

Because the interactions between some users and the computing device (112) may be more successful than the interactions between other users and the computing device (112), the other users experiencing less successful interactions with the device (112) may desire to replicate these successful user interactions. As such, the usability engine (120) of FIG. 1 may also operate generally for creating a usability observation video for a computing device being studied for usability according embodiments of the present invention by: determining that the interaction of the user (108) with the computing device (112) was successful in dependence upon success criteria; and providing the usability observation video (115) to a helpdesk server to provide assistance for other users attempting to replicate the successful interaction.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 1.

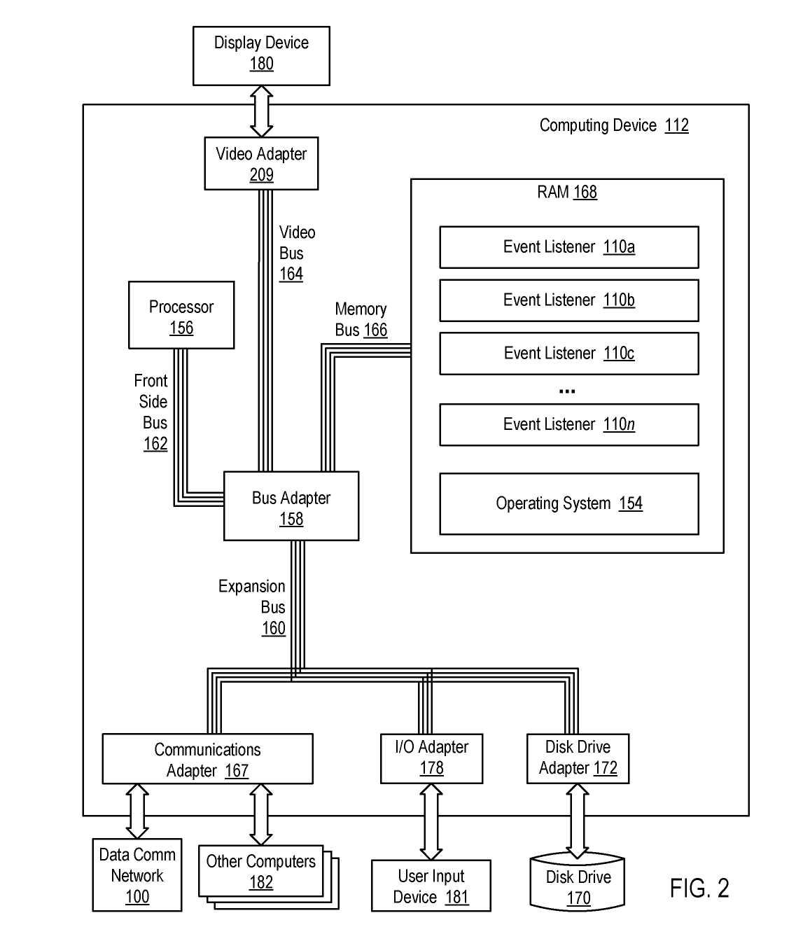

Creating a usability observation video for a computing device being studied for usability in accordance with the present invention may be implemented with one or more computing devices, that is automated computing machinery. For further explanation, therefore, FIG. 2 sets forth a block diagram of automated computing machinery comprising an exemplary computing device (112) useful in creating a usability observation video for a computing device being studied for usability according to embodiments of the present invention. The computing device (112) of FIG. 2 includes at least one computer processor (156) or ‘CPU’ as well as random access memory (168) (‘RAM’) which is connected through a high speed memory bus (166) and bus adapter (158) to processor (156) and to other components of the computing device.

Stored in RAM (168) are several event listeners (110). An event listener is a software component that detects the occurrence of an event that was generated as a result of user interaction with the device (112). The event listeners (110) of FIG. 2 may be able to detect the occurrence of events such as, for example, when a user depresses or releases a button on the device (112), when the user selects components on the device's graphical user interface, when software on the device processes a user's request or provides the user with output, and so on. An event listener may be implemented as interrupt handler, instrumentation code having instrumentation hooks embedded in other software components, a subroutine called by another software module, or any other implementation as will occur to those of skill in the art. In the example of FIG. 2, each event listener (110) operates for creating a usability observation video for a computing device being studied for usability according to embodiments of the present invention. Each event listener (110) of FIG. 2 operates for creating a usability observation video for a computing device being studied for usability according to embodiments of the present invention by detecting an event generated as a result of user interaction with the device and notifying the usability engine of the event.

Also stored in RAM (168) is an operating system (154). Operating systems useful in computing devices according to embodiments of the present invention include UNIX™, Linux™, Microsoft NT™, IBM's AIX™, IBM's i5/OS™, and others as will occur to those of skill in the art. The operating system (154) and the event listeners (110) in the example of FIG. 2 are shown in RAM (168), but many components of such software typically are stored in non-volatile memory also, for example, on a disk drive (170).

The exemplary computing device (112) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in computing devices useful according to embodiments of the present invention include the Intel Northbridge, the Intel Memory Controller Hub, the Intel Southbridge, and the Intel I/O Controller Hub. Examples of expansion buses useful in computing devices useful according to embodiments of the present invention may include Peripheral Component Interconnect (‘PCI’) buses and PCI Express (‘PCIe’) buses.

The exemplary computing device (112) of FIG. 2 also includes disk drive adapter (172) coupled through expansion bus (160) and bus adapter (158) to processor (156) and other components of the exemplary computing device (112). Disk drive adapter (172) connects non-volatile data storage to the exemplary computing device (112) in the form of disk drive (170). Disk drive adapters useful in computing devices include Integrated Drive Electronics (‘IDE’) adapters, Small Computer System Interface (‘SCSI’) adapters, and others as will occur to those of skill in the art. In addition, non-volatile computer memory may be implemented for a computing device as an optical disk drive, electrically erasable programmable read-only memory (so-called ‘EEPROM’ or ‘Flash’ memory), RAM drives, and so on, as will occur to those of skill in the art.

The exemplary computing device (112) of FIG. 2 includes one or more input/output (‘I/O’) adapters (178). I/O adapters in computing devices implement user-oriented input/output through, for example, software drivers and computer hardware for controlling output to display devices such as computer display screens, as well as user input from user input devices (181) such as keyboards and mice. The exemplary computing device (112) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computing device (112) of FIG. 2 includes a communications adapter (167) for data communications with other computers (182) and for data communications with a high speed, low latency data communications network (100). Such data communications may be carried out through Ethernet™ connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for creating a usability observation video for a computing device being studied for usability according to embodiments of the present invention include modems for wired dial-up communications, IEEE 802.3 Ethernet adapters for wired data communications network communications, and IEEE 802.11b adapters for wireless data communications network communications.

Although FIG. 2 is discussed with reference to exemplary computing devices having installed upon them event listeners, readers will note that automated computing machinery used to implement exemplary usability computers having installed upon them usability engines useful in creating a usability observation video for a computing device being studied for usability according to embodiments of the present invention are similar to the exemplary computing device (112) of FIG. 2. That is, such exemplary usability computers having installed upon them usability engines include one or more processors, bus adapters, buses, RAM, video adapters, communications adapters, I/O adapters, disk drive adapters, and other components similar to the exemplary computing device (112) of FIG. 2 as will occur to those of skill in the art.

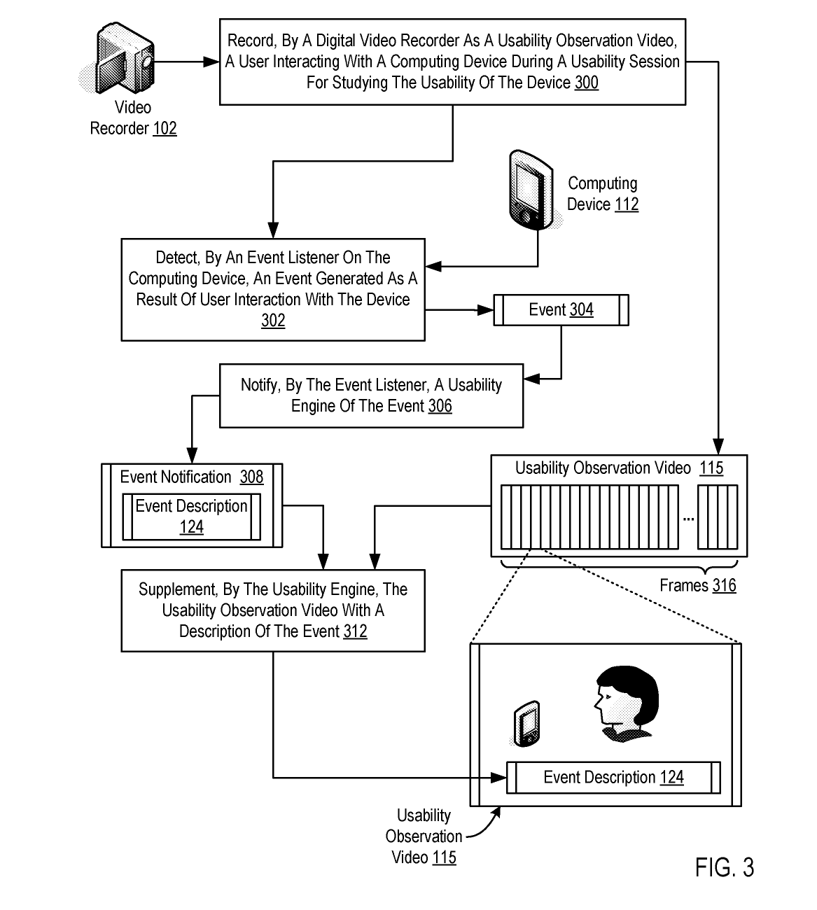

For further explanation, FIG. 3 sets forth a flow chart illustrating an exemplary method of creating a usability observation video for a computing device being studied for usability according to embodiments of the present invention. The method of FIG. 3 includes recording (300), by a digital video recorder (102) as a usability observation video (115), a user interacting with a computing device (112) during a usability session for studying the usability of the device (112). The digital video recorder (102) may record (300), as a usability observation video (115), a user interacting with a computing device (112) according to the method of FIG. 3 by converting analogue audio and video signals received from the recorders audio/visual input components into digital audio and video signals and storing the digital audio and video signals as frames (316) in a storage medium using one or more codecs as will occur to those of skill in the art.

The method of FIG. 3 also includes detecting (302), by an event listener on the computing device (112), an event (304). The event (304) of FIG. 3 represents any event generated as a result of user interaction with the device (112). Examples of events may include when a user depresses or releases a button on the device (112), when the user selects components on the device's graphical user interface, when software on the device processes a user's request or provides the user with output, and any other event as will occur those of skill in the art. An event listener is a software component that detects the occurrence of an event that was generated as a result of user interaction with the device (112). An event listener may be implemented as interrupt handler, instrumentation code having instrumentation hooks embedded in other software components, a subroutine called by another software module, or any other implementation as will occur to those of skill in the art.

Because some event listeners may only be concerned with a single event and are only executed when the event occurs, such an event listener may detect (302) an event (304) according to the method of FIG. 3 by receiving processing control of the computing device's processor upon the occurrence of the event. Processing control may be transferred to an event listener using an interrupt or through a function call directed by another software module. In other embodiments, an event listener may detect (302) an event (304) according to the method of FIG. 3 by polling hardware registers or software variables to identify whether a particular event has occurred.

The method of FIG. 3 includes notifying (306), by the event listener, a usability engine of the event (304). A usability engine is a software component that receives event notifications from one or more event listeners and administers the session log (124). The event listener may notify (306) a usability engine of the event (304) according to the method of FIG. 3 by encapsulating a description (310) of the event in an event notification message (308) and transmitting the event notification message (308) to the usability engine. The event listener may transmit the event notification message (308) to the usability engine using any message passing mechanism as will occur to those of skill in the art, including web services, a CORBA framework, and Java RMI. The event notification message (308) of FIG. 3 represents a data structure for providing a usability engine with information regarding an event that occurred on the computing device (112) in response to a user's interaction with the device (112). The description (310) of the event in an event notification message (308) may include the following exemplary information:
Date, which specifies the date on which the event was detected;
Time, which specifies the time at which the event was detected;
Priority, which specifies the level of importance of the event;
Listener Identifier, which specifies the particular listener on the computing device that detected the event; and
Event Description, which provides event specific details concerning the event.

The method of FIG. 3 also includes supplementing (312), by the usability engine, the usability observation video (115) with a description (124) of the event (304). The usability engine may supplement the usability observation video (115) with a description (124) of the event (304) by storing the event description separately from the usability observation video (115) or embedding the event description in the usability observation video (115). When storing the event description separately from the usability observation video (115), the usability engine may supplement the usability observation video (115) with a description (124) of the event (304) according to the method of FIG. 3 by recording the description (124) of the event (304) in a session log, identifying the portion of the usability observation video (115) recorded when the event (304) was detected using timecodes embedded in the usability observation video (115), and associating the description (124) of the event (304) with the identified portion of the usability observation video (115).

The timecodes embedded in the usability observation video (115) are signals typically encoded in each frame (316) of the usability observation video (115) to identify each frame and to provide the frame's relative location in the video timeline. The timecodes embedded in the usability observation video (115) may be implemented as Society of Motion Picture and Television Engineers (‘SMPTE’) timecodes, MIDI timecodes, Rewriteable Consumer timecodes, and any other timecodes as will occur to those of skill in the art.

Using the timecodes embedded in the usability observation video (115), the usability engine may identify the portion of the usability observation video (115) recorded when the event (304) was detected. As mentioned above the event description (124) for the event (304) typically specifies the time at which the event listener on the computing device (112) detected the event (304). The usability engine may, therefore, identify the portion of the usability observation video (115) recorded when the event (304) was detected by scanning the frames (316) of the usability observation video (115) to determine which frames (316) have timecodes that match the time specified in the event description (124). The usability engine may identify the frames (316) that have timecodes matching the time specified in the event description (124) as the portion of the usability observation video (115) recorded when the event (304) was detected. When matching the timecodes of the frames (316) to the time specified in the event description (124), the usability engine may take into account any timing skews that result from two different clocks being used to embed the timecodes into the frames (316) and the embed the time in the event description (124). To correct any such timing skews, the usability engine may calculate the skew between the clock used to embed the timecodes into the frames (316) and the clock used to embed the time in the event description (124) and factor in the calculated timing skew when matching the timecodes of the frames (316) to the time specified in the event description (124).

After identifying the portion of the usability observation video (115) recorded when the event (304) was detected, the usability engine may associate the description (124) of the event (304) with the identified portion of the usability observation video (115) by storing the timecodes for the frames (316) making up the identified portion of the usability observation video (115) in the session log along with the event description (124). The usability engine may also associate the description (124) of the event (304) with the identified portion of the usability observation video (115) by associating the timecodes for the frames (316) making up the identified portion of the usability observation video (115) in separate data structure from the session log with an identifier for the event description (124) recorded in the session log. Associating the description (124) of the event (304) with the identified portion of the usability observation video (115) in such a manner allows the usability engine to display the event description (124) concurrently with the corresponding portion of the usability observation video (115) that was recorded when the event (304) was detected.

As mentioned above, instead of storing the event description separately from the usability observation video (115), the usability engine may embed the event description in the usability observation video (115). When embedding the event description in the usability observation video (115), the usability engine may supplement the usability observation video (115) with a description (124) of the event (304) according to the method of FIG. 3 by identifying the portion of the usability observation video (115) recorded when the event (304) was detected using timecodes embedded in the usability observation video (115); and embedding the description (124) of the event (304) in the identified portion of the usability observation video (115). The usability engine may embed the description (124) of the event (304) in the identified portion of the usability observation video (115) by storing the event description (124) as metadata for the frames (316) that make up the identified portion of the usability observation video (115) using, for example, closed captioning channels such as Line 21 in the vertical blanking interval or those described in the Electronic Industries Alliance (‘EIA’)-708 specification, or some other metadata structures for the video as will occur to those of skill in the art.

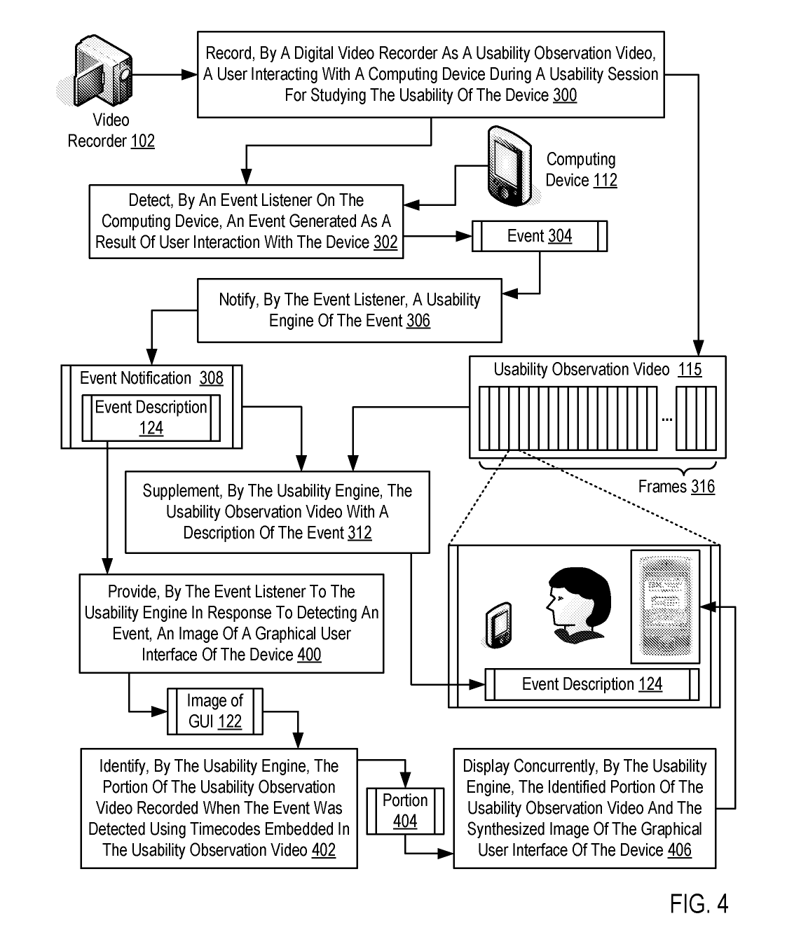

Supplementing a usability observation video with a description of an event detected by an event listener assists a usability expert viewing the video in developing a more accurate assessment of the device's usability. In addition to supplementing a usability observation video with an event description, the usability engine may also provide the usability expert with an image of the device's graphical user interface to further assist the usability expert in assessing the usability of the device. For further explanation, therefore, consider FIG. 4 that sets forth a flow chart illustrating a further exemplary method of creating a usability observation video for a computing device being studied for usability according to embodiments of the present invention.

The method of FIG. 4 is similar to the method of FIG. 3. That is, the method of FIG. 4 includes: recording (300), by a digital video recorder (102) as a usability observation video (115), a user interacting with a computing device (112) during a usability session for studying the usability of the device (112); detecting (302), by an event listener on the computing device (112), an event (304) generated as a result of user interaction with the device (112); notifying (306), by the event listener, a usability engine of the event (304); and supplementing (312), by the usability engine, the usability observation video (115) with a description (124) of the event (304). The example of FIG. 4 is also similar to the example of FIG. 3 in that the event listener employs an event notification message (308) to notify the usability engine of the event (304) and in that the usability observation video (115) stores the user interaction as a set of frames (316).

The method of FIG. 4 also includes providing (400), by the event listener to the usability engine in response to detecting an event (304), an image (122) of a graphical user interface of the device (112). The event listener may provide (400) an image (122) of a graphical user interface (‘GUI’) of the device (112) to the usability engine in response to detecting the event (304) according to the method of FIG. 4 by capturing the image (122) of the GUI rendered on the device (112) and embedding the image (122) in the event description (124) or encapsulating the image (122) in the event notification message (308) to be sent to the usability engine. The event listener may capture the image (122) of the GUI rendered on the device (122) using a variety of techniques such as, for example, requesting screen data from the operating system running on the device (112). The image of the GUI (122) may be encoded in any format as will occur to those of skill in the art including, for example, JPG, TIFF, PNG, BMP, and so on.

The method of FIG. 4 also includes identifying (402), by the usability engine, the portion (404) of the usability observation video (115) recorded when the event (304) was detected using timecodes embedded in the usability observation video (115). The usability engine may identify (402) the portion (404) of the usability observation video (115) recorded when the event (304) was detected according to the method of FIG. 4 by scanning the frames (316) of the usability observation video (115) to determine which frames (316) have timecodes that match the time specified in the event description (124). The usability engine may identify the frames (316) that have timecodes matching the time specified in the event description (124) as the portion (404) of the usability observation video (115) recorded when the event (304) was detected. When matching the timecodes of the frames (316) to the time specified in the event description (124), the usability engine may take into account any timing skews that result from two different clocks being used to embed the timecodes into the frames (316) and the embed the time in the event description (124). To correct any such timing skews, the usability engine may calculate the skew between the clock used to embed the timecodes into the frames (316) and the clock used to embed the time in the event description (124) and factor in the calculated timing skew when matching the timecodes of the frames (316) to the time specified in the event description (124).

The method of FIG. 4 also includes displaying (406) concurrently, by the usability engine, the identified portion (404) of the usability observation video (115) and the image (122) of the graphical user interface of the device (112). The usability engine may concurrently display (406) the identified portion (404) of the usability observation video (115) and the image (122) of the graphical user interface of the device (112) according to the method of FIG. 4 by overlaying the image (122) of the GUI over the frames that make up the identified portion (404) of the usability observation video (115) as the frames are displayed on a display screen. The usability engine may also concurrently display (406) the identified portion (404) of the usability observation video (115) and the image (122) of the graphical user interface of the device (112) according to the method of FIG. 4 by creating a digital video from the image (122) having a duration that matches the duration of the identified portion (404) of the usability observation video (115) and rendering the video of the image (122) and the identified portion (404) of the usability observation video (115) simultaneously on a display screen using video-on-video technology.

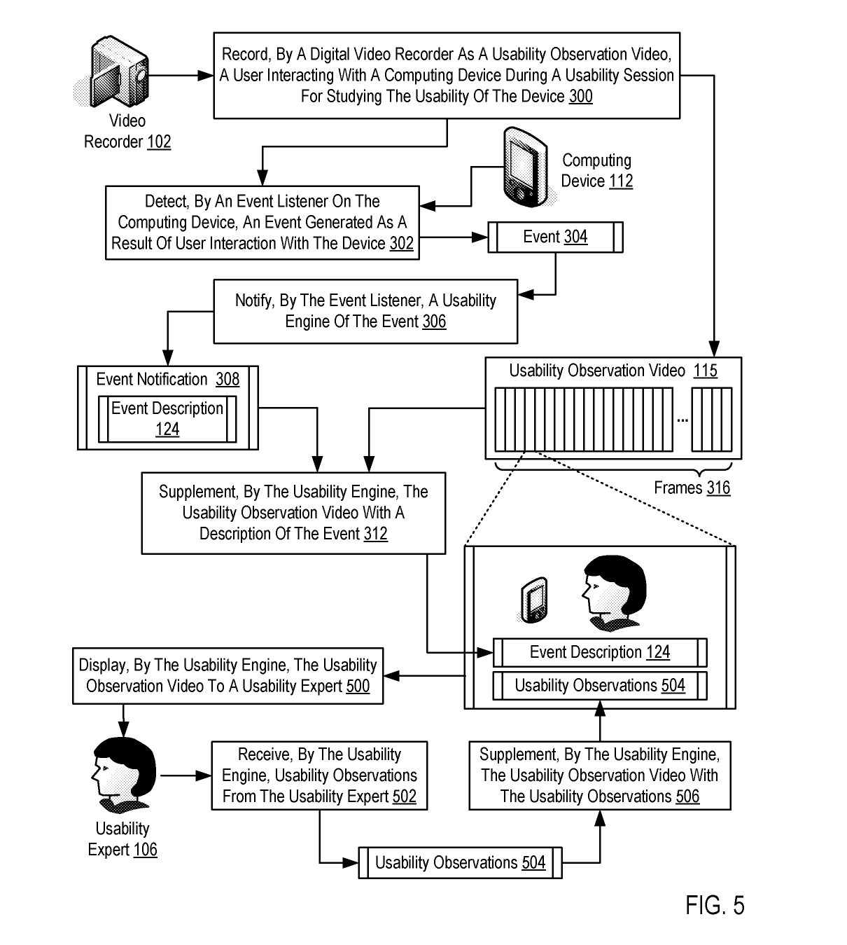

As mentioned above, a usability expert may view the usability observation video to assess the usability of a computing device. As a usability expert views the usability observation video, the usability expert may provide observation data that can be used to supplement the usability observation video. For further explanation, therefore, consider FIG. 5 that sets forth a flow chart illustrating a further exemplary method of creating a usability observation video for a computing device being studied for usability according to embodiments of the present invention.

The method of FIG. 5 is also similar to the method of FIG. 3. That is, the method of FIG. 5 includes: recording (300), by a digital video recorder (102) as a usability observation video (115), a user interacting with a computing device (112) during a usability session for studying the usability of the device (112); detecting (302), by an event listener on the computing device (112), an event (304) generated as a result of user interaction with the device (112); notifying (306), by the event listener, a usability engine of the event (304); and supplementing (312), by the usability engine, the usability observation video (115) with a description (124) of the event (304). The example of FIG. 5 is also similar to the example of FIG. 3 in that the event listener employs an event notification message (308) to notify the usability engine of the event (304) and in that the usability observation video (115) stores the user interaction as a set of frames (316).

The method of FIG. 5 includes displaying (500), by the usability engine, the usability observation video (115) to a usability expert (106). The usability engine may display (500) the usability observation video (115) to a usability expert (106) according to the method of FIG. 5 by rendering the usability observation video (115) on a display screen along with any supplemental event descriptions. The display screen may be implemented as a display for a television, desktop computer, handheld computer, projector, or any other display screen as will occur to those of skill in the art.

The method of FIG. 5 also includes receiving (502), by the usability engine, usability observations (504) from the usability expert (106). A usability observation is a description of any aspect of the user's interaction with the device that the usability expert (106) deems relevant to the usability study. For example, usability observations may describe the user's emotional state as the user operates the device (112), the speech spoken by the user to the device (112), the synthesized speech provided by the device (112) to the user, a description of how well the user appears to be operating the device, and any other aspect of the user's interaction that the usability expert (106) deems relevant to the usability study. The usability engine may receive (502) usability observations (504) from the usability expert (106) through input devices of a computer such as, for example, keyboard, mouse, microphone, stylus, or any other input device as will occur to those of skill in the art. When the usability engine is installed on the same computer used by the usability expert (106) to enter the usability observations, the usability engine may receive (502) usability observations (504) from the usability expert (106) according to the method of FIG. 5 through application programming interfaces of device drivers that administer the input devices. When the usability engine is installed on a different computer than the computer used by the usability expert (106) to enter the usability observations, the usability engine may receive (502) usability observations (504) from the usability expert (106) according to the method of FIG. 5 through a data communications connection with observation recorder software installed on the computer used by the usability expert (106) to enter the usability observations. The data communications connection may be implemented using web services, a CORBA framework, Java RMI, or any other data communications architecture as will occur to those of ordinary skill in the art. Regardless of the computer used by the usability expert (106) to enter the usability observations (504), the software receiving the observations (504) from the input device typically timestamps the observations (504) as they are entered by the usability expert (106).

The method of FIG. 5 includes supplementing (506), by the usability engine, the usability observation video (115) with the usability observations (504). The usability engine may supplement (506) the usability observation video (115) with the usability observations (504) according to the method of FIG. 5 by storing the usability observations (504) separately from the usability observation video (115) or embedding the usability observations (504) in the usability observation video (115). When storing the usability observations (504) separately from the usability observation video (115), the usability engine may supplement (506) the usability observation video (115) with the usability observations (504) according to the method of FIG. 5 by recording the usability observations (504) in a session log, identifying the portion of the usability observation video (115) recorded when the usability observations (504) were made by the expert (106) using timecodes embedded in the usability observation video (115) and timestamps on the observations (504), and associating the usability observations (504) with the identified portion of the usability observation video (115). When embedding the usability observations (504) in the usability observation video (115), the usability engine may supplement (506) the usability observation video (115) with the usability observations (504) according to the method of FIG. 5 by identifying the portion of the usability observation video (115) recorded when the usability observations (504) were made by the expert (106) using timecodes embedded in the usability observation video (115) and timestamps on the observations (504); and embedding the usability observations (504) in the identified portion of the usability observation video (115).

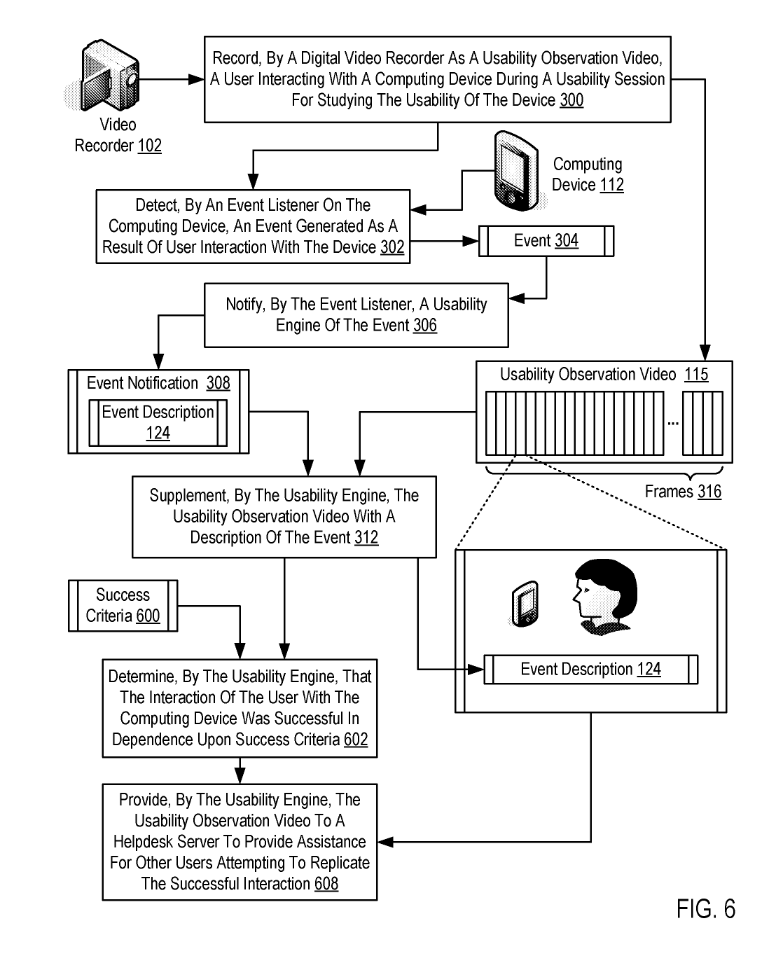

As mentioned above, interactions between some users and a particular computing device may be more successful than interactions between other users and the device. That is, some user may intuitively grasp how to use the device in a more efficient manner than other users. Because the other users experiencing less successful interactions with the device may desire to replicate more successful user interactions, a usability engine may provide a usability observation video capturing a successful user interaction to a helpdesk server to provide assistance for other users attempting to replicate the successful interaction. For further explanation, therefore, consider FIG. 6 that sets forth a flow chart illustrating a further exemplary method of creating a usability observation video for a computing device being studied for usability according to embodiments of the present invention.

The method of FIG. 6 is also similar to the method of FIG. 3. That is, the method of FIG. 6 includes: recording (300), by a digital video recorder (102) as a usability observation video (115), a user interacting with a computing device (112) during a usability session for studying the usability of the device (112); detecting (302), by an event listener on the computing device (112), an event (304) generated as a result of user interaction with the device (112); notifying (306), by the event listener, a usability engine of the event (304); and supplementing (312), by the usability engine, the usability observation video (115) with a description (124) of the event (304). The example of FIG. 6 is also similar to the example of FIG. 3 in that the event listener employs an event notification message (308) to notify the usability engine of the event (304) and in that the usability observation video (115) stores the user interaction as a set of frames (316).

The method of FIG. 6 also includes determining (602), by the usability engine, that the interaction of the user with the computing device (112) was successful in dependence upon success criteria (600). Success criteria (600) of FIG. 6 may represent a set of success rules that identify whether a user interaction with the device is successful. For example, one success rule may identify a user interaction with a device is successful upon receiving an indication from a usability expert that the user interaction was successful. As mentioned above, the usability engine may supplement the usability observation video (115) with usability observations by recording the usability observations in a session log and associating the usability observations with portions of the video (115) or embedding the usability observations directly in the video (115) as metadata for the frames (316). When the usability engine records the usability observations in a session log, the usability engine may determine (602) that the interaction of the user with the computing device was successful according to the method of FIG. 6 by parsing the session log for usability observations recorded by the usability expert (106) and determining that the parsed usability observations satisfy success conditions for any of the success rules in the success criteria (600). When the usability engine embeds the usability observations directly in the video (115), the usability engine may determine (602) that the interaction of the user with the computing device was successful according to the method of FIG. 6 by parsing the usability observation video (115) for usability observations recorded by the usability expert (106) and determining that the parsed usability observations satisfy success conditions for any of the success rules in the success criteria (600).

The success criteria (600) may also contain other type of success rules that require the usability engine to perform more complex analysis of the event descriptions received from event listeners on the device (112) to supplement the usability observation video (115). As mentioned above, the usability engine may supplement the usability observation video (115) by recording the event descriptions in a session log and associating the event description with portions of the video (115) or embedding the event descriptions directly in the video (115) as metadata for the frames (316). When the usability engine records the event descriptions in a session log, the usability engine may determine (602) that the interaction of the user with the computing device was successful according to the method of FIG. 6 by parsing the session log (124) for event descriptions and determining whether the parsed event descriptions satisfy success conditions for any of the success rules of the success criteria (600). When the usability engine embeds the event descriptions directly in the video (115), the usability engine may determine (602) that the interaction of the user with the computing device was successful according to the method of FIG. 6 by parsing the usability observation video (115) for event descriptions and determining whether the parsed event descriptions satisfy success conditions for any of the success rules of the success criteria (600).

For further explanation, consider now exemplary success criteria (600) containing a collection of success rules for determining whether the interaction of the user with the computing device (112) was successful:

TABLE 1
EXEMPLARY SUCCESS CRITERIA

| SUCCESS | |
|---|---|
| RULE ID | SUCCESS CONDITION |
| 1 | SessionLog.UsabiltyObservation = “Success” |
| 2 | UOVideo.UsabiltyObservation = “Success” |
| 3 | (SessionLog.EventDesc = “ButtonListener: |
| | Depress_Reco_Button”) && |
| | (SessionLog.EventDesc = “SpeechListner: |
| | StartListening”) && |
| | (SessionLog.EventDesc = “SpeechListner: |
| | RecoResult != NoMatch”) |
| 4 | (UOVideo.EventDesc = “ButtonListener: |
| | Depress_Reco_Button”) && |
| | (UOVideo.EventDesc = “SpeechListner: |
| | StartListening”) && |
| | (UOVideo.EventDesc = “SpeechListner: |
| | RecoResult != NoMatch”) |

The exemplary success criteria above include four success rules. Each success rule contains a success condition, which when satisfied indicates that a usability session is successful. The first success rule specifies that a usability session is successful when a session log for the usability session has value of “Success” in one of the usability observations received from a usability expert. The second success rule specifies that a usability session is successful when the usability observation video for the usability session has value of “Success” in one of the usability observations received from a usability expert and embedded in the video. The third success rule specifies that a usability session is successful when a session log contains event descriptions that specify that the user depressed the voice recognition button on the computing device, that the device listened for an utterance from the user, and that the speech recognition engine did not return a ‘NoMatch’ message, indicating that the speech recognition was successful. The fourth success rule specifies that a usability session is successful when event descriptions embedded in the usability video specify that the user depressed the voice recognition button on the computing device, that the device listened for an utterance from the user, and that the speech recognition engine did not return a ‘NoMatch’ message, indicating that the speech recognition was successful. Satisfying any one of the exemplary success conditions in the exemplary success criteria allows the usability engine to determine that the interaction of the user with the computing device (112) was successful. Readers will note that the exemplary success criteria described above are for explanation only and not for limitation. Other success criteria as will occur to those of skill in the art may also be useful in exemplary embodiments of the present invention.

The method of FIG. 6 also includes providing (608), by the usability engine, the usability observation video (115) to a helpdesk server to provide assistance for other users attempting to replicate the successful interaction. The usability engine may provide (608) the usability observation video (115) to a helpdesk server according to the method of FIG. 6 by encapsulating the usability observation video (115) into a helpdesk message and transmitting the helpdesk message to a helpdesk administration module on helpdesk server using a data communications connection implemented using, for example, web services, a CORBA framework, or Java RMI. The helpdesk administration module on the helpdesk server may then make the helpdesk instructions (606) available to other users attempting to replicate the successful user interaction recorded in the usability session.

Exemplary embodiments of the present invention are described largely in the context of a fully functional computer system for creating a usability observation video for a computing device being studied for usability. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of creating a usability observation video for a computing device being studied for usability, the method comprising:
recording, by a digital video recorder as a usability observation video, a user interacting with a computing device during a usability session for studying the usability of the device;
detecting, by an event listener on the computing device, an event generated as a result of user interaction with the device;
notifying, by the event listener, a usability engine of the event; and
supplementing, by the usability engine, the usability observation video with a description of the event.

2. The method of claim 1 wherein supplementing, by the usability engine, the usability observation video with a description of the event further comprises:
recording the description of the event in a session log;
identifying the portion of the usability observation video recorded when the event was detected using timecodes embedded in the usability observation video; and
associating the description of the event with the identified portion of the usability observation video.

3. The method of claim 1 wherein supplementing, by the usability engine, the usability observation video with a description of the event further comprises:
identifying the portion of the usability observation video recorded when the event was detected using timecodes embedded in the usability observation video; and
embedding the description of the event in the identified portion of the usability observation video.

4. The method of claim 1 further comprising:
providing, by the event listener to the usability engine in response to detecting the event, an image of a graphical user interface of the device;
identifying, by the usability engine, the portion of the usability observation video recorded when the event was detected using timecodes embedded in the usability observation video; and
displaying concurrently, by the usability engine, the identified portion of the usability observation video and the image of the graphical user interface of the device.

5. The method of claim 1 further comprising:
displaying, by the usability engine, the usability observation video to a usability expert;
receiving, by the usability engine, usability observations from the usability expert; and
supplementing, by the usability engine, the usability observation video with the usability observations.

6. The method of claim 1 further comprising:
determining, by the usability engine, that the interaction of the user with the computing device was successful in dependence upon success criteria; and
providing, by the usability engine, the usability observation video to a helpdesk server to provide assistance for other users attempting to replicate the successful interaction.

7. A system for creating a usability observation video for a computing device being studied for usability, the system comprising:
means for recording, as a usability observation video, a user interacting with a computing device during a usability session for studying the usability of the device;
means for detecting, on the computing device, an event generated as a result of user interaction with the device;
means for notifying a usability engine of the event; and
means for supplementing the usability observation video with a description of the event.

8. The system of claim 7 wherein means for supplementing the usability observation video with a description of the event further comprises:
means for recording the description of the event in a session log;
means for identifying the portion of the usability observation video recorded when the event was detected using timecodes embedded in the usability observation video; and
means for associating the description of the event with the identified portion of the usability observation video.

9. The system of claim 7 wherein means for supplementing the usability observation video with a description of the event further comprises:
means for identifying the portion of the usability observation video recorded when the event was detected using timecodes embedded in the usability observation video; and
means for embedding the description of the event in the identified portion of the usability observation video.

10. The system of claim 7 further comprising:
means for providing, to the usability engine in response to detecting the event, an image of a graphical user interface of the device;
means for identifying the portion of the usability observation video recorded when the event was detected using timecodes embedded in the usability observation video; and
means for displaying concurrently the identified portion of the usability observation video and the image of the graphical user interface of the device.

11. The system of claim 7 further comprising:
means for displaying the usability observation video to a usability expert;
means for receiving usability observations from the usability expert; and
means for supplementing the usability observation video with the usability observations.

12. The system of claim 7 further comprising:
means for determining that the interaction of the user with the computing device was successful in dependence upon success criteria; and
means for providing the usability observation video to a helpdesk server to provide assistance for other users attempting to replicate the successful interaction.

13. A computer program product for creating a usability observation video for a computing device being studied for usability, the computer program product disposed upon a computer readable medium, the computer program product comprising computer program instructions capable of:
recording, by a digital video recorder as a usability observation video, a user interacting with a computing device during a usability session for studying the usability of the device;
detecting, by an event listener on the computing device, an event generated as a result of user interaction with the device;
notifying, by the event listener, a usability engine of the event; and
supplementing, by the usability engine, the usability observation video with a description of the event.

14. The computer program product of claim 13 wherein supplementing, by the usability engine, the usability observation video with a description of the event further comprises:
recording the description of the event in a session log;
identifying the portion of the usability observation video recorded when the event was detected using timecodes embedded in the usability observation video; and
associating the description of the event with the identified portion of the usability observation video.

15. The computer program product of claim 13 wherein supplementing, by the usability engine, the usability observation video with a description of the event further comprises:
identifying the portion of the usability observation video recorded when the event was detected using timecodes embedded in the usability observation video; and
embedding the description of the event in the identified portion of the usability observation video.

16. The computer program product of claim 13 further comprising computer program instructions capable of:
providing, by the event listener to the usability engine in response to detecting the event, an image of a graphical user interface of the device;
identifying, by the usability engine, the portion of the usability observation video recorded when the event was detected using timecodes embedded in the usability observation video; and
displaying concurrently, by the usability engine, the identified portion of the usability observation video and the image of the graphical user interface of the device.

17. The computer program product of claim 13 further comprising computer program instructions capable of:
displaying, by the usability engine, the usability observation video to a usability expert;
receiving, by the usability engine, usability observations from the usability expert; and
supplementing, by the usability engine, the usability observation video with the usability observations.

18. The computer program product of claim 13 further comprising computer program instructions capable of:
determining, by the usability engine, that the interaction of the user with the computing device was successful in dependence upon success criteria; and
providing, by the usability engine, the usability observation video to a helpdesk server to provide assistance for other users attempting to replicate the successful interaction.

19. The computer program product of claim 13 wherein the computer readable medium comprises a recordable medium.

20. The computer program product of claim 13 wherein the computer readable medium comprises a transmission medium.
